(19) United States
(12) Patent Application Publication
(10) Pub. No.: US 2007/0047482 A1
(43) Pub. Date: Mar. 1, 2007

(54) Method for controlling the communication with mobile stations over a wireless network

(75) Inventors: Xavier Perez Costa, Heidelberg (DE); Jordi Palau Casellas, Heidelberg (DE); Daniel Camps Mur, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/488,127

(22) Filed: Jul. 18, 2006

(30) Foreign Application Priority Data
Aug. 23, 2005 (DE) 10 2005 040 027.2

(51) Int. Cl. H04Q 7/00

(52) U.S. Cl. 370/328

(57) ABSTRACT

A method for controlling the communication with mobile stations over a wireless network, preferably a WLAN (Wireless Local Area Network) according to the IEEE 802.11 standard, wherein the network comprises at least one access point via which the mobile stations are associated with the network, wherein the mobile stations can be set to a power save mode and wherein data frames can be received by a station in power save mode at specific service starting times is—regarding a possibly overlapping-free transmission of data frames to the mobile station at the service starting times—designed in such a way that the service starting times are determined by taking into consideration the knowledge about existing scheduled transmissions between mobile stations and the access point and/or further information.

### BACKGROUND OF THE INVENTION

1. Field of the Invention

The present invention relates to a method for controlling the communication with mobile stations over a wireless network, preferably a WLAN (Wireless Local Area Network) according to the IEEE 802.11 standard, wherein the network comprises at least one access point via which the mobile stations are associated with the network, wherein the mobile stations can be set to a power save mode and wherein data frames can be received by a station in power save mode at specific service starting times.

2. Description of the Related Art

In the area of wireless networks, the WLAN (Wireless Local Area Network) according to the IEEE 802.11 standard has become the most widely used one, and it is not only used in a private context to connect laptops or other computers to a DSL access, but moreover it is also considered as hot spot access technology to the Internet within cellular 3GPP systems or as an access technology to the IP-multimedia subsystem (IMS). Since mobile stations, which only dispose of very restricted power resources, for example, in the form of batteries, accumulators or fuel cells, are rather frequently connected to a WLAN, efficient mechanisms for saving the limited power available are required.

The IEEE 802.11e standard defines with the APSD (Automatic Power Save Delivery) a power saving method, which can be applied in infra-structure networks, i.e. in networks with one or more access points, and in ad-hoc/mesh networks. The IEEE 802.11e standard distinguishes two operation modes: Unscheduled APSD (U-APSD) and Scheduled APSD (S-APSD). See IEEE P802.11e/D13.0, pp. 138-141, January 2005. In both methods a station informs the access point when it wants to enter into APSD power save mode. After that, the mobile station enters a sleeping state in which it can not receive any incoming data frames.

Only at specific instants, the mobile station leaves the sleeping mode and can receive data frames. Therefore, starting from the moment where the mobile station enters the sleeping mode, the access point does not forward directly any data frames to the mobile station, but buffers all incoming data frames designated for the mobile station in power save mode.

The two operation modes differ in the further processing of the buffered data frames. In U-APSD, the mobile station leaves at unspecified instants the sleeping mode and informs the Access Point about the mode change. After that, the access point forwards the potentially buffered data frames to the corresponding station.

S-APSD follows another approach when transmitting data frames buffered at the access point. In S-APSD, data is forwarded at regular intervals from the access point to the mobile station. In order to do so and after the mobile station has announced that it will enter the S-APSD power save mode, the mobile station and the access point agree at which points in time a delivery of frames can be performed. At these agreed service starting times, the mobile station leaves the sleeping mode and receives data frames sent by the access point.

When agreeing on the service starting times, they can be chosen rather arbitrarily. However, even if there are only a few parallel S-APSD processes, overlapping of service periods can occur—i.e. further service starting times occur in periods during which, for example, already buffered data frames are forwarded to a mobile station.

Since the radio channel can only be used by one device at a time, overlapping service periods lead to a situation where a mobile station has to wait after having left the sleeping mode until data transmissions, that have been started beforehand during a service period, are finished. Due to these unnecessary waiting times, valuable power is consumed from the energy resource which results in a reduced operation time of a mobile station.

### SUMMARY OF THE INVENTION

Hence, the present invention is based on the task to design and further develop a method for controlling the communication of mobile stations of the above mentioned kind according to which the power consumption of the mobile stations is further reduced.

According to the invention, the task mentioned above is solved by a method showing the characteristics of patent claim 1. According to this, the proposed method is designed in such a way that the service starting times are determined by using the knowledge about existing scheduled transmissions between mobile stations and the access point and/or further information.

According to the invention, it has first been recognized that overlapping of service periods can efficiently be reduced by systematic planning when agreeing on the service starting time. According to the invention, information about the access point and the mobile stations associated with this access point, in particular the already scheduled service starting times are, is taken into consideration. By doing so, overlapping of service periods is considerably reduced. This leads to fewer collisions with other data frames and to a more constant and better predictable quality of the connections. By doing so, the mobile stations can be operated in power save mode much more efficiently, because waiting times resulting from overlapping service periods can be avoided completely or can at least be reduced considerably.

According to the invention, in order to design as easily as possible, the service starting times are determined by the access point and transmitted to the corresponding mobile station. This makes sense in particular, because the access point already has a lot of information about existing connections, as well as about the consequently necessary transmissions of control frames or the like. It is beneficial to determine the service starting times directly before a mobile station enters power save mode and to transmit it to the mobile station. In order to determine service starting times that are as adequate as possible, it can be provided that desired service starting times are indicated by a mobile station.

In order to depict the situation as simple as possible, the service starting times can be defined by a first service starting time and a service interval determining a periodical repetition of the service starting times. By doing so, the one or more following service starting times can easily be computed from any arbitrary service starting time.

Preferably, the determination of the service starting times consists basically in finding a possible optimum first service starting time. In particular, in case of S-APSD processes whose service intervals are basically an integer multiple of each other, an overlapping of service periods can rather efficiently be avoided or at least considerably reduced by these means. In some cases it can happen though that the service intervals have such an unpropitious ratio towards each other that a reduction of overlapping service periods is possible only to a very limited extent even when shifting the first service starting times in a justifiable way. Here, it can make sense to slightly change the service interval of service starting times that are to be newly scheduled, and hence to achieve a reduction of overlapping.

A possibly simple and effective optimization criterion can be indicated by the maximization of distances in time between the individual scheduled service starting times of all of the mobile stations in S-APSD power save mode being associated with the access point. With this criterion, the overlapping can easily be reduced or even completely avoided.

When determining the service starting times, the priority of the data frames possibly transmitted to the mobile stations can additionally be taken into consideration. For example, in case of an IP telephone connected to a WLAN, where it is very likely that it is only sent short signaling frames or voice frames with high priority, it is assigned such service starting times that are relatively safe from overlapping with already scheduled service periods. In contrast, the service starting times for an e-mail terminal can be scheduled in a more flexible way, because delays in transmission of data frames are comparatively less critical.

Additionally or alternatively, the assumed number of data frames that are transmitted during a service period to a mobile station can be a factor when determining the service starting times. In case of an IP telephone, for example, the service starting times are rather dense, but it is noted that only a few frames will have to be transmitted per service period. In contrast, an e-mail terminal as already mentioned will receive possibly buffered data frames at relatively long intervals, but then it is very common that the number of data frames is higher.

This fact can be reflected in that, for example in case of IP telephones, after an arbitrary service starting time, another service starting time follows after rather short times, whereas for example in the case of an e-mail terminal it should be taken care—as far as possible—that after one service starting time there will be a rather long distance in time allowed until a next service starting time.

In a particularly advantageous way the quality of the service can be enhanced due to the method according to the invention. In particular, due to a systematic scheduling of the service starting times, it can be rather exactly predicted when a service starting time will actually occur. For most of the operation situations, a delay of service starting times as a consequence of already started service periods is bounded to a certain range. Therefore, certain maximum and very probably not exceeded deviations of the actual service starting times from the agreed service starting times can be guaranteed.

In particular in case of access points which do not have a powerful processor, it can make sense to compute the service starting times for different operation situations offline and to store them in a storage, preferably at the access point, in a computed form. Here, tables are preferably used. When determining the service starting times by the access point, the memory can easily be accessed and the corresponding service starting times can be read out from there. By these means, the load on the processor of the access point is very low.

If the processors of an access point are powerful enough, the service starting times are preferably computed in real-time. To do so, an algorithm is used that can be based on very different methods known in practice. Simple algorithms that only determine possible service starting times by trial, as well as highly complex algorithms, for example, based on max-plus-algebra, can be used. The choice of the corresponding algorithm will in turn depend on the capacity of the resources available at the access point.

Regarding a design of the method that can be adjusted to possibly fit the current operation situation, the algorithm and/or the table can be exchangeable. According to the load of the access point, a correspondingly optimum algorithm or table can be chosen. In addition, if the processor of the access point is heavily loaded for a short period when determining the service starting times in real-time, it can be useful to switch temporarily to a determination of the service starting times over a table.

This heavy load could, for example, result from the fact that many mobile stations want to switch to S-APSD power save mode simultaneously. When the load on the processor of the access point reduces again, the service starting times could again be determined in real-time.

Now, there are several options of how to design and to further develop the improvements of the present invention in an advantageous way. For this purpose, it must be referred to the claims subordinate to claim 1 on the one hand and to the following explanation of a preferred example of an embodiment of the method according to the invention together with the figure on the other hand.

In connection with the explanation of the preferred embodiment of the invention with the aid of the figure, generally preferred designs and further developments of the embodiment will also be explained.

### BRIEF DESCRIPTION OF THE DRAWINGS

FIG. 1 is a schematic diagram showing an example of an embodiment of the method according to the invention with different first service starting times.

### DESCRIPTION OF THE PREFERRED EMBODIMENT

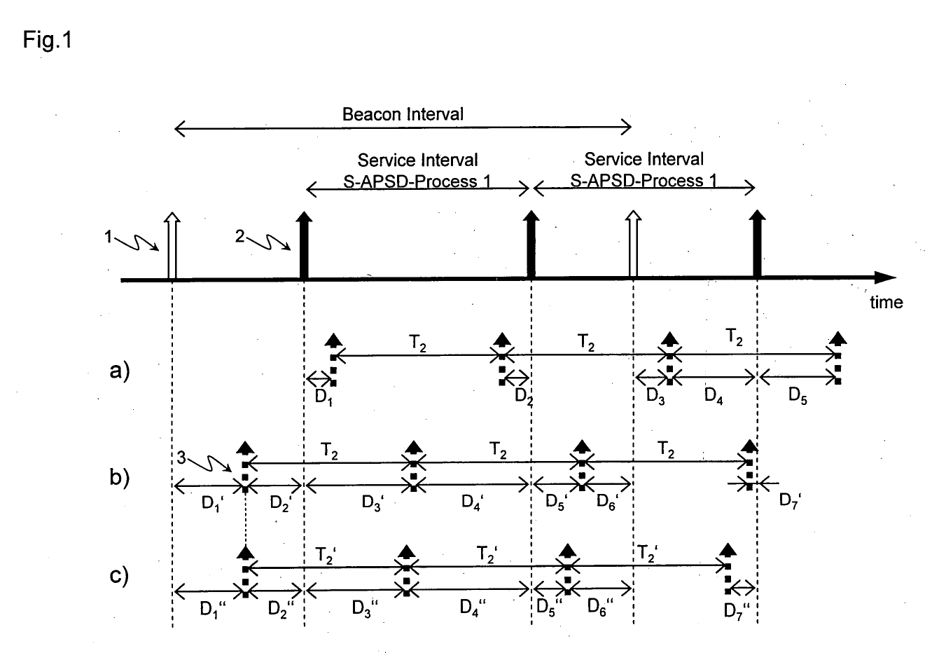

Referring to FIG. 1, as an example, three different constellations with different service starting times and service intervals are depicted. The time axis is shown in horizontal direction, the respective service starting times are indicated by vertical arrows. The top part of the figure shows the starting times already scheduled, where the radio channel is definitely blocked by the transmission of data frames. In the example of an embodiment chosen, at these starting times the periodically sent out beacons 1 that are sent for signalling purposes by the access point, and service starting times 2 as already scheduled by the access point for a mobile station MS1 are transmitted. In the sections a), b) and c) different possibilities of service starting times 3 to be scheduled for another mobile station MS2 are depicted.

In part a) of the figure, a first service starting time is chosen in such a way that in case of a given service interval T₂, a maximum distance in time between the scheduled starting times and the periodical repetitions of the first service starting time can be achieved. In order to determine the first service starting time the respective minimum distance between the individual service starting times—the possible service starting times of the mobile station MS2 and the already scheduled starting times—were considered.

When shifting the first service starting time, in general, different minimum distances occur for individual first service starting times. That first service starting time is selected where the minimum distance between the service starting times will be at a maximum. If several first service starting times are discovered, it is reasonable that the first one is chosen. The initial service starting time as selected here has the disadvantage of a rather late start. In case of applications that require an earlier start, another initial service starting time should hence be chosen.

Therefore, part b) of the figure shows an earlier first service starting time, which was suggested, for example, by the mobile station. This choice is very disadvantageous, because in case of the fourth depicted service starting time, the distance in time D₇′ becomes very small and an overlapping of the service periods of the mobile stations MS1 and MS2 is relatively likely to occur.

In case the first service starting time is actually to be chosen in such a way, it is advantageous to adjust the service interval correspondingly. Whereas in the parts a) and b) the respective service starting times with the same service interval T₂ are depicted, in part c) of the figure, the service interval was slightly reduced to T₂′. In spite of the slight variation, a distance D₇″, which is as long as the distances D₁ or D₂ in part a) of the figure, arises, i.e. similar minimum distances of the individual service starting times are the result.

The figure clearly shows that by shifting the first service starting time, overlapping of service periods arise or can be avoided by easy means. It can here be seen that very different distances in time in relation to already scheduled service starting times can arise.

Generally, for example in case of mobile stations whose data amounts and whose type of data frames sent are not known, the possibility as depicted in part a) of the figure, would have to be provided with a maximum distance to the respective other service starting times. Alternatively, the solution as depicted in part c) of the fig. could be realized.

In contrast, if it is known that, for example, the mobile station MS2 comprises an IP telephone, then even the possibility depicted in part b) could be used, because the rather short time period of D₇′ available should still be sufficient to transmit the rather low number of data frames. In this sense and depending on the assumed data frames sent, the first service starting time can be determined.

Finally, it is particularly important to point out that the completely arbitrarily chosen example of an embodiment of the teaching according to the invention from above only serves as illustration of the teaching as according to the invention, but that it does by no means restrict the latter to the given example of an embodiment.

1. A method for controlling communication with mobile stations over a wireless network, preferably a WLAN (Wireless Local Area Network) according to the IEEE 802.11 standard, wherein the network comprises at least one access point via which the mobile stations are associated with the network, wherein the mobile stations can be set to a power save mode and wherein data frames can be received by a station in power save mode at specific service starting times, wherein service starting times are determined by taking into consideration information including knowledge about existing scheduled transmissions between mobile stations and the access point.

2. The method according to claim 1, wherein the service starting times are determined by the access point and are transmitted to a mobile station.

3. The method according to claim 2, wherein the service starting times are transmitted by the access point to a mobile station directly before the mobile station enters power save mode.

4. The method according to claim 1 wherein preferred service starting times are indicated by a mobile station.

5. The method according to claim 1, wherein the service starting times are defined by a first service starting time and a service interval, with which a periodic repetition of the service starting times is determined.

6. The method according to claim 1, wherein the first service starting time and/or the service interval are changed.

7. The method according to claim 1, wherein the service starting times are determined in such a way that the distance in time between the scheduled service starting times of all the mobile stations associated with the access point is at a maximum.

8. The method according to claim 1, wherein the priority of the data frames that are possibly transmitted to the mobile station is taken into consideration when determining the service starting times.

9. The method according to claim 1, wherein the probable number of data frames that are possibly transmitted to the mobile station is taken into consideration when determining the service starting times.

10. The method according to claim 1, wherein a maximum deviation from the actual service starting times from the scheduled service starting times is guaranteed.

11. The method according to claim 1, wherein the service starting times for different operation situations are already available in a computed form and are only read out from a memory.

12. The method according to claim 11, wherein the already computed service starting times are stored in form of a table in a memory.

13. The method according to claim 1, wherein the service starting times are computed in real-time by an algorithm.

14. The method according to claim 12, wherein the algorithm and/or the table is exchangeable and/or is exchanged during the run-time.

15. The method according to claim 13, wherein the algorithm and/or the table is exchangeable and/or is exchanged during the run-time.
